(19) United States
(12) Patent Application Publication
(10) Pub. No.: US 2006/0178472 A1
(43) Pub. Date: Aug. 10, 2006

(54) Process for producing low fluorosurfactant-containing aqueous fluoropolymer dispersions with controlled pH

(76) Inventor: David William Johnson, Washington, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/351,126

(22) Filed: Feb. 9, 2006

Related U.S. Application Data
(60) Provisional application No. 60/651,604, filed on Feb. 10, 2005.

(51) Int. Cl. C08L 27/12

(52) U.S. Cl. 524/805

(57) ABSTRACT

A process for producing aqueous fluoropolymer dispersion with low fluorosurfactant content by polymerizing at least one fluoromonomer in an aqueous medium in the presence a fluorosurfactant to produce aqueous fluoropolymer dispersion having a first pH and an initial fluorosurfactant content. The process includes adding nonionic surfactant to stabilize the dispersion; contacting the stabilized fluorosurfactant-containing aqueous fluoropolymer dispersion with strong base anion exchange resin to reduce fluorosurfactant content to a predetermined level wherein the anion exchange resin is in the hydroxide form; and separating the anion exchange resin from the dispersion after the fluorosurfactant content has been reduced, the separated dispersion having a second pH. According to the invention, the first pH is sufficiently low such that an increase in pH resulting from the contacting with anion exchange resin produces a second pH less than a pH that promotes thermal degradation over volitilization of the nonionic surfactant in coating and film applications.

### FIELD OF THE INVENTION

This invention relates to a process for removing fluorosurfactant from aqueous fluoropolymer dispersions using anion exchange resin.

### BACKGROUND OF THE INVENTION

Fluoropolymers are applied to a wide number of substrates in order to confer release, chemical and heat resistance, corrosion protection, cleanability, low flammability, and weatherability. One method of applying fluoropolymers to substrates is by dispersion coating, i.e., applying the dispersion in dispersion form with the subsequent application of heat for drying and coalescence. This method is particularly useful for non-melt-processible fluoropolymers such as polytetrafluoroethylene (PTFE) homopolymers and modified PTFE but is also useful for melt-processible tetrafluoroethylene (TFE) copolymers.

Dispersion coating processes typically employ fluoropolymer dispersions in a more concentrated form than the as-polymerized dispersion. Thus, dispersions are often concentrated by a method as taught in Mark et al., U.S. Pat. No. 3,037,953, which includes the addition of a nonionic surfactant to the as polymerized dispersion, heating to above the cloud point, and removing the clear upper supernate which forms above the concentrated dispersion. In addition, to inhibit the growth of bacteria, basic compounds such as ammonium hydroxide or sodium hydroxide are added to increases the pH of the dispersion sufficiently that bacteria do not grow. Addition of base is typically done prior to concentrating the dispersion, i.e., added prior to or together with the with the addition of nonionic surfactant to the dispersion.

The concentrated dispersions used for dispersion coating thus contain a significant quantity of nonionic surfactant, e.g. 6-8 wt % percent based on the weight of fluoropolymer solids in the dispersion. Dispersion coating processes using concentrated dispersions include the steps of applying concentrated dispersion to a substrate by common techniques such as spraying, roller or curtain coating; drying the substrate to remove volatile components (primarily water and nonionic surfactant), and baking the substrate. When baking temperatures are high enough, the primary dispersion particles fuse and become a coherent mass. Baking at high temperatures to fuse particles of non-melt-processible fluoropolymer is often referred to as sintering.

As described in Berry, U.S. Pat. No. 2,559,752, fluorosurfactants are used as non-telogenic dispersing agents in the manufacture of aqueous fluoropolymer dispersions and thus, unless removed, fluorosurfactants are normally present in aqueous fluoropolymer dispersions. Due to environmental concerns and because fluorosurfactants are expensive, it is frequently desirable to reduce the fluorosurfactant content of fluoropolymer dispersions. As has been taught in U.S. Pat. No. 3,882,153 (Seki et al) and U.S. Pat. No. 4,282,162 (Kuhls), fluorosurfactants can be recovered either from the aqueous phase after the polymer has been coagulated from the dispersion or in the aqueous polymer dispersions prior to concentration. A preferred method of recovering the fluorosurfactant from the fluoropolymer dispersion as taught in both Kuhls and Seki et al. is by adsorption onto anion exchange resin. Strongly basic anion exchange resin in particular has been found useful for the nearly quantitative removal of the most commonly used fluorosurfactant, ammonium perfluorooctanoate (PFOA). To avoid the introduction of unwanted ions into the dispersion, e.g., chloride, anion exchange resins in the hydroxide form are preferred.

When the fluorosurfactant content of has been reduced using anion exchange methods and the resulting dispersions are used in dispersion coating processes, undesirable color can result. It is believed that the undesirable color is due to residues attributable to incomplete volatilization of the surfactants during drying and baking/sintering, i.e., carbon and/or colored organic decomposition products.

What is desired is a process to manufacture aqueous fluoropolymer dispersions with low fluorosurfactant content which can be applied to substrates as coatings or film without unwanted color. It is further desired to produce such fluoropolymer dispersions with low fluorosurfactant content are resistant to bacterial growth.

### BRIEF SUMMARY OF THE INVENTION

The present invention provides a process for producing aqueous fluoropolymer dispersion with low fluorosurfactant content by polymerizing at least one fluoromonomer in an aqueous medium in the presence a fluorosurfactant to produce aqueous fluoropolymer dispersion having a first pH and an initial fluorosurfactant content. The process includes adding nonionic surfactant to stabilize the dispersion; contacting the stabilized fluorosurfactant-containing aqueous fluoropolymer dispersion with strong base anion exchange resin to reduce fluorosurfactant content to a predetermined level wherein the anion exchange resin is in the hydroxide form; and separating the anion exchange resin from the dispersion after the fluorosurfactant content has been reduced, the separated dispersion having a second pH. According to the invention, the first pH is sufficiently low such that an increase in pH resulting from the contacting with anion exchange resin produces a second pH less than a pH that promotes thermal degradation over volitilization of the nonionic surfactant in coating and film applications.

In a preferred form of the invention, the process further comprises adding base to control a final pH of the dispersion to both inhibit bacterial growth and to retard thermal degradation of the nonionic surfactant in coating and film applications.

In one embodiment of the invention, the first pH is about 2 to about 5. In another embodiment the second pH is less than about 11. In a preferred embodiment, the final pH is about 9 to about 11, and more preferably about 9.5 to about 10.5.

The process preferably reduces fluorosurfactant content to a predetermined level of no greater than about 300 ppm, more preferably a predetermined level no greater than about 100 ppm, and most preferably a predetermined level of no more than 50 ppm.

The invention also provides an aqueous fluoropolymer dispersion comprising fluoropolymer particles in an aqueous medium comprising about 2 to about 11 wt % nonionic surfactant based on the weight of fluoropolymer solids in the dispersion. The dispersion has a fluoropolymer solids content of about 30 to about 70 wt %, a fluorosurfactant content of no greater than about 300 ppm and a pH of about 9 to about 11.

### DETAILED DESCRIPTION OF THE INVENTION

As discussed above, dispersion coating processes typically employ such fluoropolymer dispersions in a more concentrated form than the as-polymerized dispersion, i.e., the concentrated dispersions have a fluoropolymer solids content of about 35 to about 70 wt %. These concentrated dispersions contain a significant quantity of nonionic surfactant in the range of 2-11 wt %, typically 6-8 wt % based on the weight of fluoropolymer in the dispersion and, unless it is removed, also contain fluorosurfactant. The present invention provides a process reducing the fluorosurfactant content of the dispersion and producing dispersions with a controlled pH.

This invention is based on the discovery that the reduction of fluorosurfactant using anion exchange resins can cause the final pH of the dispersion to be too high, accelerating the thermal degradation of the nonionic surfactant used in stabilization/concentration of the dispersion when applying the dispersion to substrates to form coatings and films in the drying and baking/sintering process. The high pH is believed to promote decomposition over volitilization of surfactants during film formation leaving behind carbon and/or colored organic residues. If it is attempted to adjust the pH of the concentrated dispersion with acid to decrease pH to a level to decrease color formation, localized coagulation of the dispersion can result, forming agglomerates which adversely affect dispersion quality unless removed from the dispersion before use such as by filtration. The process of this invention can be used to controls the pH of the dispersion to avoid thermal degradation of the nonionic surfactant in coating and film applications.

In a process according to this invention, the polymer dispersion has a first pH and an initial fluorosurfactant content. Preferably, as will be discussed more fully below, the starting dispersion is an as-polymerized dispersion. After addition of a nonionic surfactant for stabilization, the dispersion is contacted with a strongly basic anion exchange resin in the hydroxide form to reduce fluorosurfactant content. After separating the anion exchange resin from the dispersion, the dispersion has a second pH which is increased above the first pH. In accordance with the invention, the first pH is sufficiently low that the second pH is less than a pH that results in thermal degradation of the nonionic surfactant in coating and film applications. Depending on the first pH, and on the initial fluorosurfactant content and other anions which determines the second pH, it may be desirable to add a base such as ammonium hydroxide or sodium hydroxide to further increase the final pH sufficiently to inhibit bacterial growth.

Fluoropolymer

The stabilized fluorosurfactant-containing aqueous fluoropolymer dispersion for treatment in accordance with the present invention is made by dispersion polymerization (also known as emulsion polymerization). The aqueous fluoropolymer dispersion to be treated is a stabilized fluorosurfactant-containing aqueous fluoropolymer dispersion which means that it contains sufficient nonionic surfactant to prevent coagulation of the dispersion when the fluorosurfactant content is reduced. Nonionic surfactant is added for stabilization prior to treatment according to the invention. After concentration, aqueous fluoropolymer dispersions are useful as coating or impregnating compositions and to make cast films.

Fluoropolymer dispersions are comprised of particles of polymers made from monomers wherein at least one of the monomers contains fluorine. The fluoropolymer of the particles of the aqueous dispersions used in this invention is independently selected from the group of polymers and copolymers of trifluoroethylene, hexafluoropropylene, monochlorotrifluoroethylene, dichlorodifluoroethylene, tetrafluoroethylene, perfluoroalkyl ethylene monomers, perfluoro(alkyl vinyl ether) monomers, vinylidene fluoride, and vinyl fluoride.

The invention is especially useful when the fluoropolymer component of the dispersion is polytetrafluoroethylene (PTFE) including modified PTFE which is not melt-processible. Polytetrafluoroethylene (PTFE) refers to the polymerized tetrafluoroethylene by itself without any significant comonomer present. Modified PTFE refers to copolymers of TFE with such small concentrations of comonomer that the melting point of the resultant polymer is not substantially reduced below that of PTFE. The concentration of such comonomer is preferably less than 1 wt %, more preferably less than 0.5 wt %. The modified PTFE contains a small amount of comonomer modifier which improves film forming capability during baking (fusing), such as perfluoroolefin, notably hexafluoropropylene (HFP) or perfluoro (alkyl vinyl) ether (PAVE), where the alkyl group contains 1 to 5 carbon atoms, with perfluoro(ethyl vinyl) ether (PEVE) and perfluoro (propyl vinyl) ether (PPVE) being preferred. Chlorotrifluoroethylene (CTFE), perfluorobutyl ethylene (PFBE), or other monomer that introduces bulky side groups into the molecule are also included. The PTFE typically has a melt creep viscosity of at least 1×10⁹ Pa·s. Such high melt viscosity indicates that the PTFE does not flow in the molten state and therefore is not melt-processible. PTFE and modified PTFE are frequently sold in dispersion form and transported in shipping containers and the process of the invention can be readily employed for reducing the fluorosurfactant content of such dispersions.

The fluoropolymer component of the dispersion may be melt-processible. By melt-processible, it is meant that the polymer can be processed in the molten state (i.e., fabricated from the melt into shaped articles such as films, fibers, and tubes etc. that exhibit sufficient strength and toughness to be useful for their intended purpose). Examples of such melt-processible fluoropolymers include copolymers of tetrafluoroethylene (TFE) and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Such fluoropolymers include polychlorotrifluoroethylene, copolymers of tetrafluoroethylene (TFE) or chlorotrifluoroethylene (CTFE). Preferred comonomers with of TFE are perfluoroolefin having 3 to 8 carbon atoms, such as hexafluoropropylene (HFP), and/or perfluoro (alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The melt-processible copolymer is made by incorporating an amount of comonomer into the copolymer in order to provide a copolymer which typically has a melt flow rate of about 1-100 g/10 min as measured according to ASTM D-1238 at the temperature which is standard for the specific copolymer. Typically, the melt viscosity will range from 10² Pa·s to about 10⁶ Pa·s, preferably 10³ to about 10⁵ Pa·s measured at 372° C. by the method of ASTM D-1238 modified as described in U.S. Pat. No. 4,380,618. Additional melt-processible fluoropolymers are the copolymers of ethylene or propylene with TFE or CTFE, notably ETFE, ECTFE and PCTFE. Further useful polymers are film forming polymers of polyvinylidene fluoride (PVDF) and copolymers of vinylidene fluoride as well as polyvinyl fluoride (PVF) and copolymers of vinyl fluoride.

Fluorosurfactants

The fluorosurfactant in the fluorosurfactant-containing dispersions to be reduced in this process is a non-telogenic, anionic dispersing agent, soluble in water and comprising an anionic hydrophilic group and a hydrophobic portion. Preferably, the hydrophobic portion is an aliphatic fluoroalkyl group containing at least four carbon atoms, all except at most one of which, and that one the closest to the solubilizing group, bearing at least two fluorine atoms, the terminal carbon atom bearing in addition an atom consisting of hydrogen or fluorine. These fluorosurfactants are used as a polymerization aid for dispersing and because they do not chain transfer, they do not cause formation of polymer with undesirable short chain length. An extensive list of suitable fluorosurfactants is disclosed in U.S. Pat. No. 2,559,752 to Berry. Preferably, the fluorosurfactant is a perfluorinated carboxylic acid having 6-10 carbon atoms and is typically used in salt form. Suitable fluorosurfactants are ammonium perfluorocarboxylates, e.g., ammonium perfluorocaprylate or ammonium perfluorooctanoate. The fluorosurfactants are usually present in the amount of 0.02 to 1 wt % with respect to the amount of polymer formed.

Ion Exchange Resin

For the practice of this invention, a strongly basic anion exchange resin in the hydroxide form is used to remove fluorosurfactant from fluoropolymer dispersion. Suitable strongly basic anion exchange resin comprises a polymer and functional groups of quaternary ammonium groups. Strong base ion exchange resins have the advantage of less sensitivity to the pH of the media. Ion exchange resins in the form of a hydroxyl counter ion are used in preference to ion exchange resin with a chloride counter ion thereby eliminating concern over chloride ion presence in the final dispersion product which could be detrimental to end-use processing equipment. The anion exchanger resin is brought into the OH⁻ form preferably by contact with the NaOH solution. Examples of suitable commercially-available strong base anion exchange resins with quaternary ammonium groups with a trimethylamine moiety include DOWEX® 550A, US Filter A464-OH, SYBRON M-500-OH, SYBRON ASB1-OH, PUROLITE A-500-OH, Itochu TSA 1200, AMBERLITE® IR 402. Examples of suitable commercially-available stong base anion exchange resins with quaternary ammonium groups with a dimethyl ethanol amine moiety include US Filter A244-OH, AMBERLITE® 410, DOWEX® MARATHON A2, and DOWEX® UPCORE Mono A2.

Anion exchange resin used in the process of the present invention is preferably monodisperse. More preferably, the anion exchange resin beads have a number average size distribution in which 95% of the beads have a diameter within plus or minus 100 μm of the number average bead diameter.

The monodisperse anion exchange resin has a particle size which provides a suitable pressure drop through the bed. Very large beads are fragile and prone to breakage. Very small anion exchange beads are susceptible to tight particle packing resulting in tortuous channels in the bed. This can result in high shear conditions and high pressure drop in the bed. Preferred anion exchange resin has a number average bead size about 450 to about 800 μm, more preferably, the anion exchange resin beads have a number average bead diameter of about 550 to about 700 μm.

Non-Ionic Surfactants

Aromatic alcohol ethoxylates can be used as the nonionic surfactant for stabilization of fluorosurfactant-containing aqueous fluoropolymer dispersion prior to ion exchange treatment and also for the concentration of such dispersions according to the teachings of Marks et al., U.S. Pat. No. 3,037,953, and in Holmes, U.S. Pat. No. 3,704,272. However, due to some concern about possible environmental effect of aromatic compounds, preferred nonionic surfactants are aliphatic alcohol ethoxylates. Suitable nonionic surfactants include any of a variety of aliphatic alcohol ethoxylates or mixtures thereof which provide the desired cloud point during concentration and which provide desired properties in the dispersion, e.g., low burn off temperature, dispersion stability, etc. Many of these nonionic surfactant compositions are disclosed in Marks et al., U.S. Pat. No. 3,037,953 and Miura et al., U.S. 6,153,688. Especially preferred nonionic surfactants are a compound or mixture of compounds of the formula:
R(OCH₂CH₂)ₙOH
wherein R is a branched alkyl, branched alkenyl, cycloalkyl, or cycloalkenyl hydrocarbon group having 8-18 carbon atoms and n is an average value of 5 to 18 as disclosed in Cavanaugh EP 1472307 A1. The stabilized dispersion preferably contains 2-11 wt % nonionic surfactant based on the weight of fluoropolymer solids in the dispersion.
Process

A typical process for the aqueous dispersion polymerization of preferred polymer PTFE is a process wherein TFE vapor is fed to a heated reactor containing fluorosurfactants, paraffin wax and deionized water. A chain transfer agent may also be added if it is desired to reduce the molecular weight of the PTFE. A free-radical initiator solution is added and, as the polymerization proceeds, additional TFE is added to maintain the pressure. The exothermic heat of reaction is removed by circulating cooling water through the reactor jacket. After several hours, the feeds are stopped, the reactor is vented and purged with nitrogen, and the raw dispersion in the vessel is transferred to a cooling vessel. Paraffin wax is removed and the dispersion is isolated and stabilized with nonionic surfactant. The stabilized fluoropolymer dispersion will have a first pH and an initial fluorosurfactant content, typically greater than about 500 ppm up a level of about 2500 ppm. In a preferred embodiment, the first pH is about 2 to about 5. In necessary or desirable, the first pH can be adjusted, for example, by the addition of dilute mineral acid, preferably dilute sulfuric acid.

Fluoropolymer dispersion so produced will contain some amount of ferric ions either from the metal equipment used in polymerization and processing or from the addition of iron compounds such as catalysts etc. or due to their presence in the water itself. In process of this invention an effective amount of suitable chelating agent is preferably added to stabilized fluorosurfactant-containing aqueous fluoropolymer dispersion prior to contacting the fluorosurfactant-containing aqueous fluoropolymer dispersion with anion exchange resin in the hydroxide form. In this way, a strongly bonded iron complex is formed and scum formation is prevented.

Any of a variety of techniques which bring the dispersion in contact with the anion exchange resin can be used for carrying out the ion exchange process. For example, the process can be carried out by addition of ion exchange resin bead to the dispersion in a stirred tank, in which a slurry of the dispersion and resin is formed, followed by separation of dispersion from the anion exchange resin beads by filtration. Another suitable method is to pass the dispersion through a fixed bed of anion exchange resin instead of using a stirred tank. Flow can be upward or downward through the bed and no separate separation step is needed since the resin remains in the fixed bed.

The preferred process permits reducing the fluorosurfactant content of a fluorosurfactant—containing aqueous fluoropolymer dispersion to a predetermined level, preferably a level no greater than about 300 ppm, more preferably a predetermined level no greater than about 100 ppm, especially a predetermined level no greater than about 50 ppm.

In accordance the invention, when the first pH is sufficiently low (dependent on the amount of fluorosurfactant and other anions present), contacting the dispersion with anion exchange resin results in an increase in pH that produces a second pH less than a pH which promotes thermal degradation over volitilization of said nonionic surfactant in coating and film applications. In accordance with the invention, the lower first pH avoids raising the pH too high and thus avoids the need to add acid which can cause coagulation problems as discussed previously. In a preferred embodiment the second pH is less than about 11.

After ion exchange treatment, the aqueous fluoropolymer dispersion with reduced fluorosurfactant content is transferred to a dispersion concentration operation. Prior to dispersion concentration, the final pH of the dispersion is typically controlled to above 9 as necessary by the addition of a base such as an ammonium hydroxide or sodium hydroxide solution in order to prevent bacterial growth in the dispersion. In preferred embodiments, the final pH is controlled to about 9 to about 11, more preferably about 9.5 to 10.5. In the dispersion concentration operation, the dispersion is concentrated with the aid of a nonionic surfactant as taught in Marks et al., U.S. Pat. No. 3,037,953, and in Holmes, U.S. Pat. No. 3,704,272 to raise the solids from nominally 35 wt % to about 60 wt %. Miura et al., U.S. Pat. No. 6,153,688 discloses a similar process. The nonionic surfactant will already be present since it was added for stabilization when the raw dispersion is prepared (after wax removal) for ion exchange treatment. If it is desired to added additional nonionic surfactant prior to or after concentration, the same or a different nonionic surfactant can be used.

As described herein, the contacting of the stabilized dispersion with anion exchange resin has been carried out before concentration. This may be advantageous because of the low solids dispersion has lower viscosity and processing is facilitated. The process of this invention may also be carried out on stabilized dispersion which has already been concentrated provided that the concentrated dispersion has a suitable first pH for the practice of the invention.

The fluorosurfactant can be recovered from the anion exchange resin if desired or the resin with the fluorosurfactant can be disposed of in an environmentally acceptable method, e.g., by incineration. If it is desired to recover the fluorosurfactant, the fluorosurfactant may be removed from resin by elution. Elution of fluorosurfactant adsorbed on the anion exchange resin is readily achieved by a mixture of dilute mineral acid with organic solvent (e.g., HCl/ethanol) as demonstrated by Kuhls in U.S. Pat. No. 4,282,162, or by strong mineral acids such as sulfuric acid and nitric, transferring the adsorbed fluorinated carboxylic acid to the eluent. The fluorosurfactant in the eluent in high concentration can easily be recovered in the form of a pure acid or in the form of salts by common methods such as acid-deposition, salting out, or other forms of concentration etc.

The dispersion polymerization of melt-processible TFE copolymers is similar except that one or more comonomers are added to the batch initially and/or introduced during polymerization. In addition, a telogen such as a hydrocarbon is employed to control the molecular weight to achieve the desired melt flow of the polymer for the intended purpose. The same dispersion concentration operation used for PTFE dispersions can be used for TFE copolymer dispersions.

Dispersions produced according to the present invention can provide coatings and films for substrates such as metal and glass fabric. Coatings prepared according to the invention have minimized unwanted color because of reduced thermal degradation of surfactant present in dispersions with controlled pH. The dispersions are applied to substrates and baked to form a baked layer on the substrate as is known in the art. When baking temperatures are high enough, the primary dispersion particles fuse and become a coherent mass. Coating compositions of dispersions of this invention can be used to coat fibers of glass, ceramic, polymer or metal and fibrous structures such as conveyor belts or architectural fabrics, e.g., coated glass fabrics. The coatings of this invention when used to coat metal substrates have great utility in coating cooking utensils such as frying pans and other cookware as well as bakeware and small electrical household appliances such as grills and irons. Coatings of this invention can also be applied to equipment used in the chemical processing industry such as mixers, tanks and conveyors as well as rolls for printing and copying equipment. Alternately, the dispersions can be used to impregnate fibers for sealing applications and filtration fabrics. Further, the dispersions of this invention can be deposited onto a support and subsequently dried, thermally coalesced, and stripped from the support to produce self-supporting films cast from the dispersion. Such cast films are suitable in lamination processes for covering substrates of metal, plastic, glass, concrete, fabric and wood.

Product

The invention provides an aqueous fluoropolymer dispersion comprising fluoropolymer particles in an aqueous medium comprising about 2 to about 11 wt % nonionic surfactant based on the weight of fluoropolymer solids in the dispersion. The dispersion has a fluoropolymer solids content of about 30 to about 70 wt %, a fluorosurfactant content of no greater than about 300 ppm, and a pH of about 9 to about 11. Preferably, the PH is about 9.5 to about 10.5. Preferably, the aqueous fluoropolymer dispersion has a fluorosurfactant content of no greater than about 100 ppm, more preferably no greater than about 50 ppm. The preferred low fluorosurfactant dispersion in accordance with the invention is especially well-suited for dispersion coating applications since it is not prone to undesirable color formation upon baking/sintering. In addition, the preferred low fluorosurfactant dispersion is resistant to bacterial growth.

What is claimed is:

1. A process for producing aqueous fluoropolymer dispersion with low fluorosurfactant content comprising:
polymerizing at least one fluoromonomer in an aqueous medium in the presence a fluorosurfactant to produce aqueous fluoropolymer dispersion having a first pH and an initial fluorosurfactant content;
adding nonionic surfactant to stabilize said dispersion;
contacting said stabilized fluorosurfactant-containing aqueous fluoropolymer dispersion with strong base anion exchange resin to reduce fluorosurfactant content to a predetermined level, said anion exchange resin being in the hydroxide form;
separating said anion exchange resin from said dispersion after the fluorosurfactant content has been reduced, said separated dispersion having a second pH;
and
wherein said first pH is sufficiently low that an increase in pH resulting from said contacting with said anion exchange resin produces a second pH less than a pH which promotes thermal degradation over volitilization of said nonionic surfactant in coating and film applications.

2. The process of claim 1 further comprising adding base to control a final pH of said dispersion to both inhibit bacterial growth and to retard thermal degradation of said nonionic surfactant in coating and film applications.

3. The process of claim 1 wherein said first pH is about 2 to about 5.

4. The process of claim 1 wherein said second pH is less than about 11.

5. The process of claim 2 wherein said final pH is about 9 to about 11.

6. The process of claim 2 wherein said final pH is about 9.5 to about 10.5.

7. The process of claim 1 further comprising forming a film or coating from said dispersion.

8. The process of claim 1 further comprising concentrating said dispersion.

9. The process of claim 1 further wherein said anion exchange resin comprises a polymer with functional groups comprising quaternary ammonium groups.

10. The process of claim 1 wherein said contacting said fluorosurfactant-containing aqueous fluoropolymer dispersion with anion exchange resin reduces fluorosurfactant content to a predetermined level of no greater than about 300 ppm.

11. The process of claim 1 wherein said contacting said fluorosurfactant-containing aqueous fluoropolymer dispersion with anion exchange resin reduces fluorosurfactant content to a predetermined level of no greater than about 100 ppm.

12. The process of claim 1 wherein said contacting said fluorosurfactant-containing aqueous fluoropolymer dispersion with anion exchange resin reduces fluorosurfactant content to a predetermined level of no greater than about 50 ppm.

13. The process of claim 1 where said initial fluorosurfactant content is at least about 500 ppm.

14. An aqueous fluoropolymer dispersion comprising fluoropolymer particles in an aqueous medium comprising about 2 to about 11 wt % nonionic surfactant based on the weight of fluoropolymer solids in the dispersion, said dispersion having a fluoropolymer solids content of about 30 to about 70 wt %, a fluorosurfactant content of no greater than about 300 ppm, and a pH of about 9 to about 11.

15. The aqueous fluoropolymer dispersion of claim 14 having a pH of about 9.5 to about 10.5.

16. The aqueous fluoropolymer dispersion of claim 14 having a fluorosurfactant content of no greater than about 100 ppm.

17. The aqueous fluoropolymer dispersion of claim 14 having a fluorosurfactant content of no greater than about 50 ppm.
